(19) United States
(12) Patent Application Publication
(10) Pub. No.: US 2011/0231656 A1
(43) Pub. Date: Sep. 22, 2011

(54) SYSTEM AND METHODS FOR AUTHENTICATING A RECEIVER IN AN ON-DEMAND SENDER-RECEIVER TRANSACTION

(75) Inventor: Giovanni Di Crescenzo, Madison, NJ (US)

(73) Assignee: TELCORDIA TECHNOLOGIES, INC., Piscataway, NJ (US)

(21) Appl. No.: 12/724,495

(22) Filed: Mar. 16, 2010

(51) Int. Cl. H04L 9/32

(52) U.S. Cl. 713/155

(57) ABSTRACT

A system and method are provided for authenticating a first device to a second device. This involves determining, at the directory, a secret key and a first set of images by communicating with the first device; receiving, at the directory, a transaction request from the second device to authenticate the first device; and generating, at the directory, a tag using said secret key and first information associated with said transaction request. This also involves selecting a second set of images from said first set of images according to said tag, and sending said second set of images from the directory to the second device. Moreover, using said first set of images, said secret key, and said information associated with said transaction request, the first device may select a third set of images that, when sent to the second device, may be used at the second device, in comparison to said second set of images, to authenticate the first device.

### BACKGROUND

1. Technical Field

This invention generally relates to a system and methods for authenticating a receiver in an on-demand sender-receiver transaction.

2. Description of the Related Art

Communication among electronic devices is widespread and can take many forms. In some cases, a client computer communicates with a server computer to enter into a transaction. The transaction may be sensitive in nature and may involve accessing a password-protected account on the server. For example, a user may use an electronic device to connect to a server in order to access a bank account and conduct online banking transactions. In other cases, peer devices may communicate with each other to share files, chat, or conduct voice over IP (VoIP) telephone calls.

In electronic communication, a danger exists of a third party impersonating one of the communicating parties. If a third party is able to successfully impersonate one of the communicating parties, then the third party may be able to access private information, such as bank account passwords, credit card information, or any other private information that is electronically communicated.

FIG. 1 illustrates a system 100, in which a third party is able to access private information using anelectronic communication. System 100 includes sender 102, intended receiver 104, and impersonating receiver 106. Sender 102, intended receiver 104, and impersonating receiver 106 are computing devices that are electrically or optically connected to each other, for example, by a computer network.

Sender 102 may be a client computer attempting to log in to intended receiver 104, which may be a server at a bank that can perform bank transactions, for example. As such, sender 102 sends a communication 108 to intended receiver 104. In the absence of impersonating receiver 106, intended receiver 104 would receive intended communication 110. Intended communication 110 is shown as a dotted line in FIG. 1, because it may never reach intended receiver 104, and may be intercepted by impersonating receiver 106.

Impersonating receiver 106 receives intercepted communication 112 from sender 102. Impersonating receiver 106 establishes a bidirectional communication link 114 with sender 102 by pretending to be intended receiver 104. Intended receiver 104 may not know that sender 102 attempted to communicate with it.

For example, if a user of sender 102 was logging into his or her bank account, the user may direct his browser to go to the web address of the user's bank, which should enable the user to access intended receiver 104. Impersonating receiver 106 may intercept that communication and respond with a webpage, which looks similar to the webpage that intended receiver 104 would normally provide. The user at sender 102 may then provide his or her user name and password information to impersonating receiver 106, mistakenly thinking that this information is being provided to intended receiver 104. Impersonating receiver 106 may then capture the user name and password information, and then would have full access to the user's bank account.

One proposed solution is for the user and intended receiver 104 to agree on an authenticating symbol at registration. This way, when the user accesses intended receiver 104, intended receiver 104 sends back the agreed-upon authenticating symbol. By contrast, if impersonating receiver 106 intercepted the communication and sent a webpage to sender 102, the webpage would not include the authenticating symbol, because impersonating server 106 would have no knowledge of the authenticating symbol. If the webpage received at sender 102 does not include the authenticating symbol, then the user knows that its communication partner cannot be trusted, and the user can refrain from providing any sensitive information. In this way, the user can authenticate that he or she is communicating with intended receiver 104 and not impersonating receiver 106.

There are alternative solutions. The first one is based on first setting a public-key infrastructure (PKI) and then using certificates released by a Certification Authority (CA). For instance, when a client uses a computer to visit a website, the client is often guaranteed that the website is authentic (as opposed to being a counterfeit copy from an impostor) by the fact that the client's browser verifies the website's certificate, released by a trusted CA (e.g., Verisign).

While such techniques are considered very secure, they are also known to rate poorly in terms of usability, as they are hard to deploy (not all networks can afford to set up a PKI) and difficult to maintain (if not periodically managed, the above verification will not work). Also, such verifications are often ignored by users who visit the website, even after being notified that the verification was not successful (i.e., if the website's certificate has expired).

Browser phishing filters detect whether a website being visited has features similar to a known “phish” website, i.e., a website that is put up by an impostor rather than by the entity claimed in the website. Such filters perform relatively well in terms of usability because not much is needed to maintain them; however, these filters rate poorly in terms of security, as skilled impostors understand how to overcome them. A well-known example is the E-bay toolbar using the Account Guard method.

Recent techniques that have made a huge step towards solving the problem include Bank of America's SiteKey system and variants thereof, which work as follows. The user provides the server with a shared secret, such as an image or passphrase, in addition to his or her regular password. The server shows this shared secret to the user, who is asked to recognize it before providing the server with the user's password. The biggest weakness of this technique is that the server must display the shared secret in order to authenticate itself to the user.

One drawback with the Bank of America solution is the possibility of an impersonating receiver 106 learning of the authenticating symbol. If the secret is observed or captured, the image can be replayed by an impostor, who would then be able to mislead the user into believing that he or she was visiting an authentic website. This could happen, for example, at sender 102 if someone sees the authenticating symbol on a display screen of sender 102; such an occurrence is known as a “spying attack” or a “shoulder attack.” Alternatively, the impersonating receiver 106 may monitor communication between sender 102 and intended receiver 104 over time to determine the authenticating symbol.

Another drawback with this solution is that it requires registration between the sender and the receiver ahead of time. This may be impractical, for example, in VoIP telephone calls between peer electronic devices. Generally, it may be difficult for a large number of peer devices to each register with each other before being able to communicate.

Still, prior art systems of the type discussed above are today used by essentially anyone having online access to a bank account. Other shortcomings of these systems are discussed in the paper entitled, “Phish and HIPs: Human Interactive Proofs to Detect Phishing Attacks,” by Dhamija et al., in Henry S. Baird, Daniel P. Lopresti (Eds.): Human Interactive Proofs, Second International Workshop, HIP 2005, Bethlehem, Pa., USA, May 19-20, 2005, Proceedings. Lecture Notes in Computer Science 3517 Springer 2005, ISBN 3-540-26001-3. Pages 127-141

### SUMMARY

in accordance with this invention, there is provided a method for authenticating a first device to a second device, the method comprising the steps of: determining, at the directory, a secret key and a first set of images by communicating with the first device; receiving, at the directory, a transaction request from the second device to authenticate the first device; generating, at the directory, a tag using the secret key and first information associated with the transaction request; selecting a second set of images from the first set of images according to the tag; sending the second set of images from the directory to the second device; whereby using the first set of images, the secret key, and the information associated with the transaction request, the first device may select a third set of images that, when sent to the second device, may be used at the second device, in comparison to the second set of images, to authenticate the first device.

In accordance with this invention, there is further provided a system for authenticating a first device to a second device using a directory, the system including a first processor associated with the directory and programmed to: determine a secret key and a first set of images from communication with the first device; receive a transaction request from the second device to authenticate the first device; generate a first tag using the secret key and first information associated with the first transaction request; select a second set of images from the first set of images according to the first tag; and send the second set of images to the second device.

In accordance with this invention, there is further provided a computer-readable medium comprising program instructions, which, when executed by a processor, cause the processor to perform a method for authenticating a first device to a second device, the method comprising the steps of: determining, at the directory, a secret key and a first set of images by communicating with the first device; receiving, at the directory, a transaction request from the second device to authenticate the first device; generating, at the directory, a tag using the secret key and first information associated with the transaction request; selecting a second set of images from the first set of images according to the tag; sending the second set of images from the directory to the second device; whereby using the first set of images, the secret key, and the information associated with the transaction request, the first device may select a third set of images that, when sent to the second device, may be used at the second device, in comparison to the second set of images, to authenticate the first device.

In accordance with this invention, there is further provided a method for authenticating a first device to a second device using a directory, including the steps of: determining, at the directory, a secret key and a first set of images by communicating with the first device; determining, at the first device, the secret key and the first set of images by communicating with the directory; sending a transaction request from the second device to the directory; receiving the transaction request at the directory from the second device to authenticate the first device; generating, at the directory, a first tag using the secret key and first information associated with the transaction request; selecting, at the directory, a second set of images from the first set of images according to the first tag; sending the second set of images from the directory to the second device; receiving, at the second device, the second set of images from the directory; receiving, at the first device, the first information associated with the first transaction request; generating, at the first device, a second tag using the secret key and the first information associated with the transaction request; selecting, at the first device, a third set of images from the first set of images according to the second tag; sending the third set of images from the first device to the second device; receiving, at the second device, the third set of images from the first device; and comparing the second and third sets of images.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 illustrates a system in which a third party is able to access private information in electronic communication.

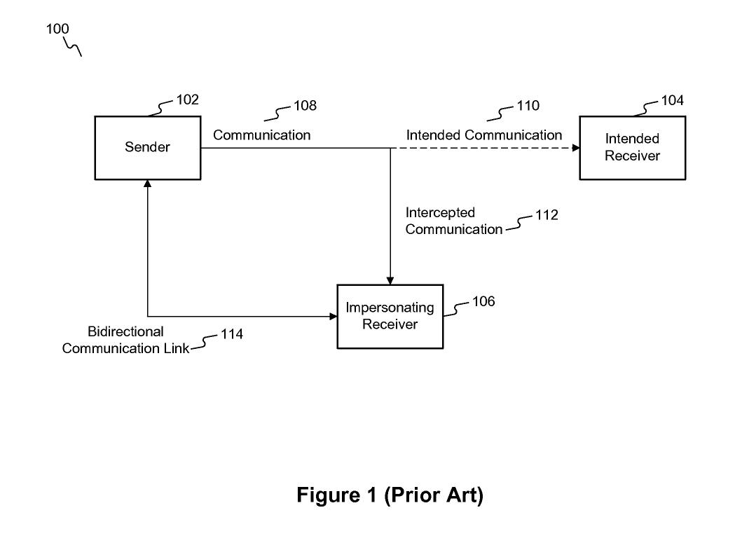

FIG. 2 illustrates a system for a sender to authenticate a receiver without first registering with the receiver.

FIG. 3 is a flow diagram illustrating a process for authenticating a receiver without first registering with the receiver.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

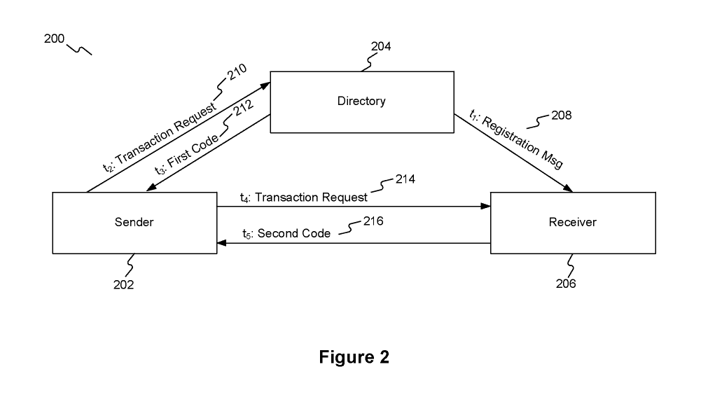

FIG. 2 illustrates a system 200 for a sender to authenticate a receiver without first registering with the receiver. System 200 may include sender 202, directory 204, and receiver 206. Sender 202, directory 204, and receiver 206 may be electronic devices, including one or more from the group of: a client, a server, a desktop computer, a laptop computer, a netbook, a PDA, or any other electronic device. Sender 202 and receiver 206 may be peer electronic devices for entering into a VoIP telephone call. Sender 202, directory 204, and receiver 206 may each include at least one processor configured to execute program instructions stored on at least one computer-readable medium. Sender 202, directory 204, and receiver 206 may each include input ports and output ports configured to communicate with each other by any type of connection, including directly, indirectly, or via a network. Sender 202, directory 204, and receiver 206 may be individual computing devices, or they may be distributed across multiple computing devices. Alternatively, sender 202, directory 204, and receiver 206 may execute on the same device or any number of devices.

At a time t₁, directory 204 may send a registration message 208 to receiver 206. Registration message 208 may include a plurality of images and a secret key k. Receiver 206 may use the plurality of images and the secret key k to authenticate itself to sender 202.

Later, sender 202 seeks to enter into a transaction with receiver 206. For example, sender 202 may seek to enter into a VoIP telephone call with receiver 206. Sender 202 may seek to authenticate the identity of receiver 206 to ensure that sender 202 does not connect to an impersonating device. In this way, sender 202 may seek to protect any confidential information that may be transmitted during the VoIP telephone call.

Therefore, at a time t₂, sender 202 sends a transaction request 210 to directory 204. Directory 204 may be an entity at which devices available to enter a VoIP telephone call may register. At a time t₃, directory 204 may send a first code 212 to sender 202 in response to transaction request 210. Directory 204 may calculate first code 212 using the secret key k and the plurality of images that directory 204 sent to receiver 206 in registration message 208 at the time t₁. First code 212 may include a subset of images from the plurality of images selected on the basis of the secret key k.

At a time t₄, sender 202 may send a transaction request 214 to receiver 202. Transaction request 214 may be similar or identical to transaction request 210. Sender 202 may send transaction request 214 simultaneously with transaction request 210. In response, at a time t₅, receiver 206 may send a second code 216 to sender 202. Receiver 206 may calculate second code 216 using the secret key k and the plurality of images that directory 204 sent to receiver 206 in registration message 208 at the time t₁. Second code 216 may include a subset of images from the plurality of images selected on the basis of the secret key k.

Sender 202 may compare the first code 212 with the second code 216. For example, sender 202 may perform a calculation to determine if first code 212 is the same as second code 216. Alternatively, sender 202 may display first code 212 and second code 216 to a user of sender 202 for the user to make the comparison.

If sender 202 (or the user of sender 202) determines that first code 212 is the same as or substantially similar to second code 216, then sender 202 authenticates receiver 206 as a communications partner. This is because sender 202 can assume that directory 204 and receiver 206 both share private information used to generate first code 212 and second code 216, and that receiver 206 has registered with directory 204.

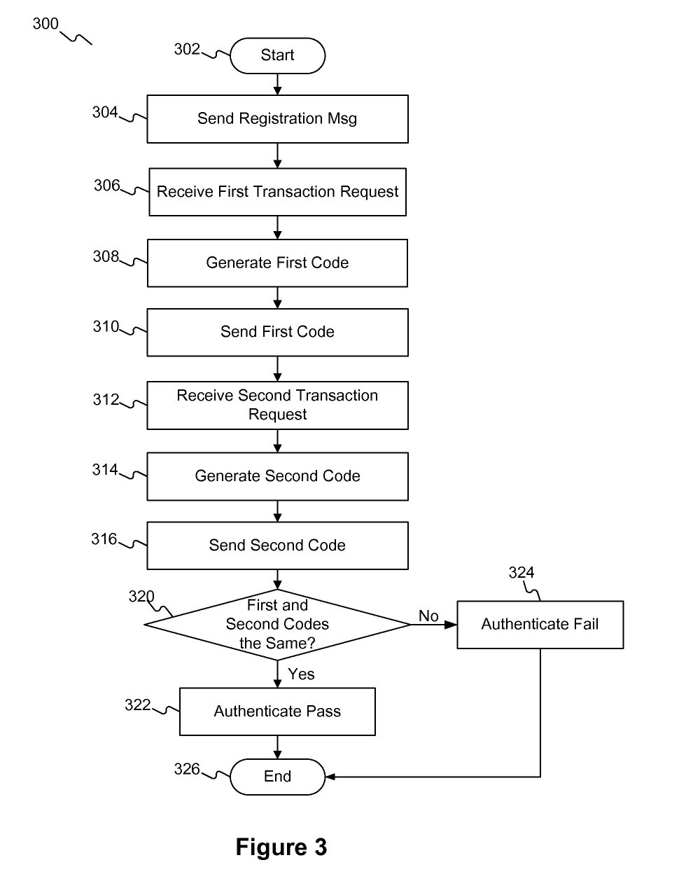

FIG. 3 is a flow diagram illustrating a process 300 for a sender to authenticate a receiver without first registering with the receiver. Process 300 may be carried out by program instructions stored on at least one computer-readable medium that may be executable by at least one processor in at least one of sender 202, directory 204, and receiver 206 from FIG. 2.

Process 300 starts at block 302. At block 304, directory 204 may send a registration message to receiver 206. The registration message may include a secret key k and a plurality of images. At block 306, directory 204 may receive a first transaction request from sender 202. At block 308, directory 204 may generate a first code in response to the first transaction request. The first code may be generated according to the secret key k and the plurality of images. At block 310, directory 204 may send the first code to sender 202.

At block 312, receiver 206 may receive a second transaction request from sender 202. The second transaction request may relate to the same transaction as the first transaction request. Specifically, the first transaction request and the second transaction request may relate to a transaction that sender 202 seeks to enter with receiver 206, such as a VoIP telephone call. At block 314, receiver 206 generates a second code in response to the second transaction request. The second code may be generated according the secret key k and the plurality of images received from directory 204. At block 316, receiver 206 may send the second code to the sender 202.

At block 320, sender 202 may evaluate whether or not the first code and the second code are the same or substantially similar. If the first code and the second code are the same or substantially similar (block 320—Yes), then sender 202 authenticates receiver 206 at block 322. This is because sender 202 can confirm that receiver 206 has similar information as directory 204 in order to generate the same or similar code. Sender 202 assumes that receiver 206 has similar information as directory 204 because receiver 206 had successfully registered with directory 204.

Alternatively, if the first code is different from the second code (block 320—No), then sender 202 does not authenticate receiver 206 at block 324. This is because sender 202 assumes that receiver 206 has not registered with directory 204. Process 300 ends at block 326.

The first code and the second code may be calculated in different ways. In some embodiments, both a directory and a receiver possess a secret key k and a database of m images IM(1), . . . IM(m). The code may be a series of the images chosen according to the secret key k.

In order to calculate the appropriate code, both the directory and the receiver may first apply a message authentication code (MAC). The MAC may be a hash function, which takes secret key k, an ID of the sender, an ID of the receiver, and an approximate time as inputs, and outputs a tag. The sender ID, receiver ID, and time may be determined from transaction requests sent by the sender to both the directory and the receiver. As such, the tag may be calculated as follows:

tag=MAC(k,senderID,receiverID,time) [Equation 1]

The value of tag may be a binary string. In some embodiments, the length of tag may be 100 bits or more. The directory and the receiver may seek to associate the value of tag with one or more of the images from the database of m images. These one or more images may ultimately be used as a code to send to the sender.

However, the number of images m in the database may be considerably less than the number that can be represented by 100 bits or more. Accordingly, it may be necessary to associate multiple images with a single value of tag. One way of accomplishing this is to break tag into a series of smaller sub-tags with values that are matched closer to the number of images m in the database of images.

In one example, the database may include 1024 images. In other words, m=1024. If tag is 100 bits, then it may be necessary to break tag into 10 separate subtags of 10 bits each, such that tag={tag₁ . . . tag₁₀}. Each of tag₁ through tag₁₀ is composed of 10 bits, which can represent up to 1024 possible values. In other words, the value of any of tag₁ through tag₁₀, after being converted from binary to decimal, can be in the range of 0-1023 (1024 separate values). Because the database also includes 1024 images, each of the sub-tags can select one unique image from the database of 1024 images. Moreover, because there are 10 sub-tags (of tag₁ through tag₁₀), then 10 total images can be selected by the sub-tags, one image from each of tag₁ through tag₁₀. The images may be selected according to the following equation:

IM=IM(tag₁),IM(tag₂), . . . IM(tag₁₀), [Equation 2]

where IM is a series of 10 images selected from the m images by tag₁ through tag₁₀. In Equation 2, the 10 bit value of tag is used as an index into the database of images. For example, if tag₁, after being converted from binary to decimal, is associated with a value of 72, then IM(tag₁) may be the 72nd image in the database of images.

Both the receiver and the directory may calculate their own IM, based on the secret key k, the database of images, the sender ID, the receiver ID, and the time. The series of images may be a code sent from both the directory and the receiver to the sender. The sender may receive the series of images IM from both the directory and the receiver. If the series of images IM received from the directory are the same as or similar to the series of images IM received from the receiver, then the sender determines that both the sender and the receiver have access to the same secret key k and the same database of images. The sender then assumes that the receiver had previously registered with the directory, and therefore authenticates the receiver as a communications partner.

The sender may not need processing capabilities to compare the code received from the directory with the code received from the receiver. Instead, if the codes are a series of images IM determined from Equation 2, the sender may display both the codes/images received from the directory and the codes/images received from the receiver. A user of the sender may then compare the codes by looking at both series of displayed images and determining if they are the same.

However, in some embodiments, the sender may be able to execute processing to determine whether or not the code received from the directory is the same as the code received from the receiver. For example, the codes may be a tags. Because tags are numbers, the server may be able to execute processing to compare the codes/tags received from the directory with the codes/tags received from the receiver to determine if they are the same.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for authenticating a first device to a second device, the method comprising the steps of:
determining, at the directory, a secret key and a first set of images by communicating with the first device;
receiving, at the directory, a transaction request from the second device to authenticate the first device;
generating, at the directory, a tag using said secret key and first information associated with said transaction request;
selecting a second set of images from said first set of images according to said tag;
sending said second set of images from the directory to the second device; whereby
using said first set of images, said secret key, and said information associated with said transaction request, the first device may select a third set of images that, when sent to the second device, may be used at the second device, in comparison to said second set of images, to authenticate the first device.

2. The method of claim 1, wherein said first information includes at least a portion of a time value, a first device ID, and a second device ID extracted from said transaction request.

3. The method of claim 2, wherein the step of generating said tag further comprises the steps of:
calculating said tag by applying a message authentication code function to said first information and said secret key, said tag including a plurality of bits;
dividing said bits of said tag into a plurality of sub-tags; and
wherein the step of selecting a second set of images includes selecting one of said first set of images with said sub-tags, each of said images of said second set of images being associated with one of said sub-tags.

4. The method of claim 3, wherein the step of calculating said tag further comprises the step of:
applying said message authentication code function as a hash function.

5. A system for authenticating a first device to a second device using a directory, the system including:
a first processor associated with said directory and programmed to:
determine a secret key and a first set of images by communicating with the first device;
receive a transaction request from the second device to authenticate the first device;
generate a first tag using said secret key and first information associated with said first transaction request;
select a second set of images from said first set of images according to said first tag; and
send said second set of images to the second device.

6. The system of claim 5, further including:
a second processor associated with said first device and programmed to:
determine said secret key and said first set of images by communicating with said first processor;
receive said first information associated with said transaction request;
generate a second tag using said secret key and said first information associated with said transaction request;
select a third set of images from said first set of images according to said second tag; and
send said third set of images to the second device.

7. The system of claim 6, further including:
a third processor associated with said second device and programmed to:
send said transaction request to the directory;
receive said second set of images from said first processor;
receive said third set of images from said first device; and
display said second set of images and said third set of images to a user of the second device, whereby a user of said second device authenticates the first device by comparing said second and third sets of images.

8. The system of claim 7, wherein said third processor is further programmed to send said transaction request to the first device.

9. The system of claim 7, wherein said first processor is further programmed to send said transaction request to the first device.

10. The system of claim 5, wherein:
said first information includes at least a portion of a time value, a first device ID, and a second device ID extracted from said first transaction request; and
said second information includes at least a portion of a time value, a first device ID, and a second device ID extracted from a second transaction request.

11. The system of claim 5, 6, or 7, wherein said first processor is further programmed to:
calculate said first tag by applying a message authentication code function to said first information and said secret key, said first tag including a plurality of bits;
divide said bits of said first tag into a plurality of sub-tags; and
select one of said first set of images with said sub-tags, each of said images of said second set of images being associated with one of said sub-tags.

12. The system of claim 6 or 7, wherein said second processor is further programmed to:
calculate said second tag by applying a message authentication code function to said first information and said secret key, said second tag including a plurality of bits;
divide said bits of said second tag into a plurality of sub-tags; and
select one of said first set of images with said sub-tags, each of said images of said third set of images being associated with one of said sub-tags.

13. The system of claim 12, wherein said first processor is further programmed to:
calculate said first tag by applying said message authentication code function as a hash function.

14. The system of claim 13, wherein said second processor is further programmed to:
calculate said second tag by applying said message authentication code function as a hash function.

15. A computer-readable medium comprising program instructions, which, when executed by a processor, cause said processor to perform a method for authenticating a first device to a second device, the method comprising the steps of:
determining, at the directory, a secret key and a first set of images by communicating with the first device;
receiving, at the directory, a transaction request from the second device to authenticate the first device;
generating, at the directory, a tag using said secret key and first information associated with said transaction request;
selecting a second set of images from said first set of images according to said tag;
sending said second set of images from the directory to the second device;
using said first set of images, said secret key, and said information associated with said transaction request, the first device may select a third set of images that, when sent to the second device, may be used at the second device, in comparison to said second set of images, to authenticate the first device.

16. The computer-readable medium of claim 15, wherein:
said information includes at least a portion of a time value, a first device ID, and a second device ID extracted from said transaction request.

17. The computer-readable medium of claim 15, wherein the step of generating said tag further comprises the steps of:
calculating said tag by applying a message authentication code function to said first information and said secret key, said tag including a plurality of bits;
dividing said bits of said tag into a plurality of sub-tags; and
wherein the step of selecting a second set of images includes selecting ones of said first set of images with said sub-tags, each of said images of said second set of images being associated with one of said sub-tags.

18. The computer-readable medium of claim 17, wherein the step of calculating said tag further comprises the step of:
applying said message authentication code function as a hash function.

19. A method for authenticating a first device to a second device using a directory, including the steps of:
determining, at the directory, a secret key and a first set of images by communicating with the first device;
determining, at the first device, said secret key and said first set of images by communicating with the directory;
sending a transaction request from the second device to the directory;
receiving said transaction request at the directory from the second device to authenticate the first device;
generating, at the directory, a first tag using said secret key and first information associated with said transaction request;
selecting, at the directory, a second set of images from said first set of images according to said first tag;
sending said second set of images from the directory to the second device;
receiving, at the second device, said second set of images from said directory;
receiving, at the first device, said first information associated with said first transaction request;
generating, at the first device, a second tag using said secret key and said first information associated with said transaction request;
selecting, at the first device, a third set of images from said first set of images according to said second tag;
sending said third set of images from the first device to the second device;
receiving, at the second device, said third set of images from said first device; and
comparing said second and third sets of images.
